(19) United States
(12) Patent Application Publication
(10) Pub. No.: US 2025/0391889 A1
(43) Pub. Date: Dec. 25, 2025

(54) Bipolar plate and electrochemical device comprising a bipolar plate

(71) Applicant: EKPO Fuel Cell Technologies GmbH, Dettingen (DE)

(72) Inventors: Arno BAYER, Dettingen (DE); Joachim SCHERER, Dettingen (DE)

(21) Appl. No.: 19/311,770

(22) Filed: Aug. 27, 2025

Related U.S. Application Data
(63) Continuation of application No. PCT/EP2024/055615, filed on Mar. 4, 2024.

(30) Foreign Application Priority Data
Mar. 16, 2023 (DE) 10 2023 106 626.9

(51) Int. Cl. H01M 8/0263; H01M 8/0247; H01M 8/0267

(52) U.S. Cl. CPC H01M 8/0263; H01M 8/0247; H01M 8/0267

(57) ABSTRACT

In order to create a bipolar plate for an electrochemical unit of an electrochemical device comprising a plurality of electrochemical units, wherein the bipolar plate comprises an anode gas flow field, a cathode gas flow field, and a coolant flow field,
wherein the anode gas flow field comprises anode gas flow channels that are able to be flowed through by the anode gas, the cathode gas flow field comprises cathode gas flow channels that are able to be flowed through by the cathode gas, and the coolant flow field comprises coolant flow channels that are able to be flowed through by the coolant, in which bipolar plate the bipolar plate layers are materially bondable to one another without impairing the cooling function of the bipolar plate, it is proposed
that at least one anode gas flow channel and/or at least one cathode gas flow channel is locally expanded by at least one adjacent portion of a coolant flow channel being locally displaced along a transverse direction of the anode gas flow channel and or the cathode gas flow channel and by a portion of a further anode gas flow channel or a further cathode gas flow channel adjacent to the locally displaced portion of the coolant flow channel being locally narrowed, wherein the anode-side bipolar plate layer and the cathode-side bipolar plate layer are materially bonded to one another at at least one connection region within the respective locally expanded region.

### RELATED APPLICATIONS

This application is a continuation of international application number PCT/EP2024/055615 filed on 4 Mar. 2024 and claims the benefit of German application number 10 2023 106 626.9 filed on 16 Mar. 2023.

The present disclosure relates to the subject matter disclosed in international application number PCT/EP2024/055615 of 4 Mar. 2024 and German application number 10 2023 106 626.9 of 16 Mar. 2023, which are incorporated herein by reference in their entirety and for all purposes.

### FIELD OF THE DISCLOSURE

The present invention relates to a bipolar plate for an electrochemical unit of an electrochemical device comprising a plurality of electrochemical units that follow one another along a stack direction, wherein the bipolar plate comprises the following:
an electrochemically active region, which comprises an anode gas flow field that is able to be flowed through by an anode gas transversely to the stack direction, a cathode gas flow field that is able to be flowed through by a cathode gas transversely to the stack direction, and a coolant flow field that is able to be flowed through by a coolant transversely to the stack direction,
   wherein the anode gas flow field comprises anode gas flow channels that are able to be flowed through by the anode gas, the cathode gas flow field comprises cathode gas flow channels that are able to be flowed through by the cathode gas, and the coolant flow field comprises coolant flow channels that are able to be flowed through by the coolant,
   wherein the anode gas flow field is formed on an anode-side bipolar plate layer and the cathode gas flow field is formed on a cathode-side bipolar plate layer.

The bipolar plate layers are preferably made of a metallic material and are connected to one another in a gas-tight manner by a connecting process, often a laser welding process.

The bipolar plate layers must distribute the anode gas and the cathode gas as uniformly as possible over the electrochemically active region of the bipolar plate and guide between them the coolant for cooling the electrochemically active region of the electrochemical device.

In addition, the bipolar plate layers must have a very good electrical conductivity in order to ensure the electrical function of the electrochemical device.

For example, the anode-side bipolar plate layer and/or the cathode-side bipolar plate layer may be made of a rustproof, austenitic steel, preferably the steel with the material number 1.4404.

The specific electrical resistance of the steel with the material number 1.4404 is about 0.75 Ω·mm²/m.

Such a steel forms a natural passive layer (chromium oxide layer) on its surface, said layer having a low electrical conductivity. It is therefore necessary to provide the bipolar plate with a conductive coating on the outer sides of the bipolar plate layers each facing toward an electrode of a membrane electrode unit.

If the inner sides of the bipolar plate layers facing toward one another are not provided with such a conductive coating, then said inner sides of the bipolar plate layers must be materially bonded to one another in order to ensure the necessary electrical conductivity between the bipolar plate layers of the bipolar plate.

Such a material bond can be established, for example, by a welding seam, wherein the welding seam may be interrupted and comprise welding seam portions that are separate from one another (stitch welds) or welding points (spots).

Such a welding connection can be produced, in particular, by laser welding.

For welding such conductive seams, the region in which the anode-side bipolar plate layer and the cathode-side bipolar plate layer abut against one another and are able to be welded, i.e., the channel base of the anode gas flow channel and/or the channel base of the cathode gas flow channel at which the welding is to take place, must have a minimum width due to the summation of manufacturing tolerances, which result, e.g., from the tolerance of the width of the welding seam, from the tolerance in the positioning of the welding seam relative to the bipolar plate layers, and the tolerance of the relative positioning of the bipolar plate layers to one another.

This minimum channel width is, for example, in the range of at least 0.2 mm.

However, more recent developments in the field of bipolar plate technology tend toward ever narrower channel structures in order to improve the gas distribution dynamics and to ensure a sufficient support of the neighboring components, in particular the membrane electrode arrangements.

Narrower anode gas flow channels or cathode gas flow channels reduce the weldability of the bipolar plate layers in the flow fields or at least the process capability, which with larger production volumes necessarily leads to more rejects.

In the case of the bipolar plate according to EP 2 181 474 B1, the coolant channels formed between the bipolar plate layers are locally tapered in order to locally expand an anode gas flow channel or cathode gas flow channel adjoining the tapered coolant channels.

However, this reduces the cross section of the respective tapered coolant channel that is able to be flowed through by the coolant, which locally reduces the cooling capacity of the bipolar plate.

In accordance with an embodiment of the invention, a region is created on an anode gas flow channel or on a cathode gas flow channel that is sufficiently wide for the connection of the anode-side bipolar plate layer and the cathode-side bipolar plate layer, without impairing the cooling function of the bipolar plate.

### SUMMARY OF THE INVENTION

In accordance with an embodiment of the invention, in a bipolar plate in accordance with the preamble of claim 1 according to a first alternative of the present invention, provision is made that at least one anode gas flow channel is locally expanded by at least one portion of a coolant flow channel adjacent to the anode gas flow channel being locally displaced along a transverse direction of the anode gas flow channel oriented perpendicularly to the local longitudinal direction of the anode gas flow channel and perpendicularly to the stack direction and by a portion of a further anode gas flow channel adjacent to the locally displaced portion of the coolant flow channel being locally narrowed,
wherein the anode-side bipolar plate layer and the cathode-side bipolar plate layer are materially bonded to one another at at least one connection region within the locally expanded region of the anode gas flow channel and/or within the locally expanded region of the cathode gas flow channel.

Furthermore, in accordance with an embodiment of the invention, in a bipolar plate in accordance with the preamble of claim 1 according to a second alternative of claim 1, provision is made that at least one cathode gas flow channel is locally expanded by at least one portion of a coolant flow channel adjacent to the cathode gas flow channel being locally displaced along a transverse direction of the cathode gas flow channel oriented perpendicularly to the local longitudinal direction of the cathode gas flow channel and perpendicularly to the stack direction and by a further cathode gas flow channel adjacent to the locally displaced portion of the coolant flow channel being locally narrowed,
wherein the anode-side bipolar plate layer and the cathode-side bipolar plate layer are materially bonded to one another at at least one connection region within the locally expanded region of the anode gas flow channel and/or within the locally expanded region of the cathode gas flow channel.

In a particular embodiment of the invention, provision is made that the connection region is configured as a stitch weld.

In a preferred embodiment of the invention, provision is made that the extent e of the connection region along the local longitudinal direction of the anode gas flow channel is greater than the width B″ₐ of the channel base of the anode gas flow channel in the locally expanded region of the anode gas flow channel and/or that the extent e of the connection region along the local longitudinal direction of the cathode gas flow channel is greater than the width B″ₖ of the channel base of the cathode gas flow channel in the locally expanded region of the cathode gas flow channel.

The anode-side bipolar plate layer and the cathode-side bipolar plate layer are preferably welded to one another at a connection region, particularly preferably by laser welding.

The greatest width B″ₐ of the channel base of locally expanded region of the anode gas flow channel or the greatest width B″ₖ of the channel base of the locally expanded region of the cathode gas flow channel is preferably at least 0.1 mm, in particular at least 0.15 mm, particularly preferably at least 0.2 mm.

The width B_{c} of the displaced portion of the coolant flow channel is preferably substantially equal to the width B_{c} of an undisplaced portion of the coolant flow channel adjacent to the displaced portion.

The flank angles αₐ and αₖ by which the flanks of the displaced portion of the coolant flow channel are inclined relative to a contact plane of the anode-side bipolar plate layer and the cathode-side bipolar plate layer perpendicular to the stack direction are preferably substantially equal to the flank angles da and ak respectively by which the flanks of a portion of the coolant flow channel adjacent to the displaced portion are inclined relative to the contact plane.

In principle, it is sufficient if only one portion of one single coolant flow channel adjacent to the anode gas flow channel is locally displaced along the transverse direction and a further anode gas flow channel adjacent to this coolant flow channel is locally narrowed, and/or if only one portion of one single coolant flow channel adjacent to the cathode gas flow channel is locally displaced along the transverse direction and a further cathode gas flow channel adjacent to this coolant flow channel is narrowed.

A locally asymmetrical expansion of the respective anode gas flow channel or the respective cathode gas flow channel is achieved in this way.

In contrast, in a different embodiment of the invention, provision is made that portions of two coolant flow channels adjacent to the anode gas flow channel are locally displaced away from one another along the transverse direction and two further anode gas flow channels adjacent to these two coolant flow channels are locally narrowed, and/or in that portions of two coolant flow channels adjacent to the cathode gas flow channel are locally displaced away from one another along the transverse direction and two further cathode gas flow channels adjacent to these two coolant flow channels are narrowed.

A locally symmetrical expansion of the respective anode gas flow channel or the respective cathode gas flow channel is achieved in this way.

Here, provision is preferably made that the displaced portions of the coolant flow channels adjacent to the anode gas flow channel or the cathode gas flow channel are locally displaced to an equal extent along the transverse direction relative to undisplaced portions of these coolant flow channels.

In order to be able to produce a sufficient electrical conductivity between the bipolar plate layers of the bipolar plate, it is advantageous if the bipolar plate has a multitude of connection regions. The plurality of connection regions may be distributed non-uniformly over the bipolar plate or may be arranged in a regular pattern that has a first periodicity length P₁ along a longitudinal direction of the bipolar plate and a second periodicity length P₂ along a transverse direction of the bipolar plate oriented perpendicularly to the longitudinal direction and perpendicularly to the stack direction. The periodicity length P₁ and/or the periodicity length P₂ may be constant across the bipolar plate or may be different in different regions of the flow fields of the bipolar plate or may vary along the flow direction of the anode gas and/or the cathode gas.

It can hereby be achieved, for example, that a lower density of connection regions per unit area is present in a region of the bipolar plate with lower electrical current flow from bipolar plate to bipolar plate.

The concept underlying both alternatives of the invention explained above is to create a sufficiently wide contact area between the bipolar plate layers for producing a connecting seam by locally expanding the connection region, not by tapering an adjacent coolant channel, but rather by narrowing the two adjacent anode gas flow channels or cathode gas flow channels.

This creates an expanded planar region that is available for the production of a connection seam, for example a welding seam.

At least one of the adjacent coolant channels hereby locally yields to the connection region without tapering and returns to its original position immediately after the expanded region of the anode gas flow channel or the cathode gas flow channel.

At least one, particularly preferably two, of the respective adjacent anode gas flow channels or cathode gas flow channels tapers locally to create space for the production of a material bond of the bipolar plate layers at a connection region.

The locally expanded regions of an anode gas flow channel or a cathode gas flow channel preferably repeat at regular intervals across the respective flow field.

This preferably concerns not just one anode gas flow channel or cathode gas flow channel, but rather a plurality of anode gas flow channels or cathode gas flow channels extending in parallel with one another.

In principle, it is even possible that all anode gas flow channels or cathode gas flow channels are locally expanded, such that a very large number of suitable locations are available for the material bond of the bipolar plates to one another.

In the case of the bipolar plate in accordance with the invention, the flank angles of the coolant channels preferably remain constant even in the region of the local expansion of an anode gas flow channel or a cathode gas flow channel.

The width of a web at which a membrane electrode arrangement abuts against one of the bipolar plate layers of the bipolar plate preferably also remains unchanged in the region of the local expansion of an anode gas flow channel or a cathode gas flow channel.

If the width of the channel base of an anode gas flow channel or a cathode gas flow channel is already nearly sufficient for the bipolar plate layers to be materially bonded to one another in this region, then it may be sufficient for only one of the adjacent cooling channels to yield in the transverse direction of the respective flow channel, while the respective other adjacent cooling channel does not yield in the transverse direction, such that an asymmetrical web arrangement is created in the region of the local expansion of the anode gas flow channel or the cathode gas flow channel.

Both in the case of the symmetrical local expansion and in the case of the asymmetrical local expansion of a flow channel, the adjacent anode gas flow channels or cathode gas flow channels are locally constricted.

To achieve a sufficient electrical conductivity between the bipolar plate layers of the bipolar plate, the local expansions of a respective anode gas flow channel or a respective cathode gas flow channel are distributed over the respective flow field in a repeating pattern.

In accordance with a further alternative of the present invention, provision is made in a bipolar plate with the features of the preamble of claim 11 that
a) at least one anode gas flow channel has a redirecting region at which it changes its through-flow direction, wherein a channel base of the redirecting region abuts against a channel base of a cathode gas flow channel in an overlap region,
and/or
b) at least one cathode gas flow channel has a redirecting region at which it changes its through-flow direction, wherein a channel base of the redirecting region abuts against a channel base of an anode gas flow channel in an overlap region,
wherein the anode-side bipolar plate layer and the cathode-side bipolar plate layer are materially bonded to one another within the respective overlap region at at least one connection region.

Thus, underlying this alternative of the invention is concept that the flow channels in the flow fields are not designed to be rectilinear, but instead have a meandering structure. This creates redirecting regions of the anode gas flow channels and the cathode gas flow channels, and intersecting planar contact regions are created between the channel base of an anode gas flow channel and a cathode gas flow channel. These redirecting regions may be kept free in a targeted manner as planar welding regions for the formation of welding seams and may be designed to be suitable for welding. These planar welding regions may repeat periodically across the flow field.

In a preferred embodiment of this alternative of the invention, provision is made that the extent f of the overlap region along the local through-flow direction of the anode gas flow channel in the portions before and/or after the redirecting region of the anode gas flow channel or the extent f of the overlap region along the local through-flow direction of the cathode gas flow channel in the portions before and/or after the redirecting region of the cathode gas flow channel is greater than the width Bₐ of the channel base of the anode gas flow channel or the width Bₖ of the channel base of the cathode gas flow channel outside of the respective redirecting region.

In order to be able to produce a sufficient electrical conductivity between the bipolar plate layers of the bipolar plate, it is advantageous if the bipolar plate has a multitude of redirecting regions. The plurality of redirecting regions may be distributed non-uniformly over the bipolar plate or may be arranged in a regular pattern that has a first periodicity length P₁ along a longitudinal direction of the bipolar plate and a second periodicity length P₂ along a transverse direction of the bipolar plate oriented perpendicularly to the longitudinal direction and perpendicularly to the stack direction. The periodicity length P₁ and/or the periodicity length P₂ may be constant across the bipolar plate or may be different in different regions of the flow fields of the bipolar plate or may vary along the flow direction of the anode gas and/or the cathode gas. It can hereby be achieved, for example, that a lower density of redirecting regions per unit area and thus also a lower density of connection regions per unit area is present in a region of the bipolar plate with lower electrical current flow from bipolar plate to bipolar plate.

The bipolar plate in accordance with the invention, according to each of the alternatives described above, is suited, in particular, for use in an electrochemical device comprising a plurality of electrochemical units that follow one another along a stack direction and each comprise a respective bipolar plate in accordance with the invention.

Such an electrochemical device may be, for example, a fuel cell device or an electrolyzer.

The electrochemical unit in which the bipolar plate in accordance with the invention is used preferably comprises a polymer electrolyte membrane.

Further features and advantages of the invention are subject matter of the subsequent description and the graphical representation of exemplary embodiments.

### BRIEF DESCRIPTION OF THE DRAWINGS

FIG. 1 shows a plan view of the anode side of a bipolar plate for an electrochemical unit of an electrochemical device comprising a plurality of electrochemical units that follow one another along a stack direction, wherein the bipolar plate comprises an electrochemical active region, which comprises an anode gas flow field that is able to be flowed through by an anode gas transversely to the stack direction, a cathode gas flow field that is able to be flowed through by a cathode gas transversely to the stack direction, and a coolant flow field that is able to be flowed through by a coolant transversely to the stack direction,
wherein the anode gas flow field comprises anode gas flow channels that are able to be flowed through by the anode gas, the cathode gas flow field comprises cathode gas flow channels that are able to be flowed through by the cathode gas, and the coolant flow field comprises coolant flow channels that are able to be flowed through by the coolant, wherein the anode gas flow field is formed on an anode-side bipolar plate layer and the cathode gas flow field is formed on a cathode-side bipolar plate layer,
wherein an anode gas flow channel is locally expanded by portions of two coolant flow channels adjacent to the anode gas flow channel being locally displaced along a transverse direction of the anode gas flow channel oriented perpendicularly to the local longitudinal direction of the anode gas flow channel and perpendicularly to the stack direction and by respective portions of further anode gas flow channels adjacent to one of the locally displaced portions of the coolant flow channels being locally narrowed, and
wherein the anode-side bipolar plate layer and the cathode-side bipolar plate layer are materially bonded to one another at the connection region, preferably by welding, within the locally expanded region of the anode gas flow channel.

FIG. 2 shows a cross-section through the bipolar plate from FIG. 1 in a region outside of the local expansion of the anode gas flow channel, along the line 2-2 in FIG. 1;

FIG. 3 shows a cross-section through the bipolar plate from FIG. 1, in the region of the local expansion of the anode gas flow channel, along the line 3-3 in FIG. 1;

FIG. 4 shows a plan view of the anode side of a bipolar plate, which has a multitude of connection regions that each are arranged in a locally expanded region of an anode gas flow channel and further are arranged in a regular pattern that has a first periodicity length P₁ along a longitudinal direction of the bipolar plate and a second periodicity length P₂ along a transverse direction of the bipolar plate oriented perpendicularly to the longitudinal direction and perpendicularly to the stack direction;

FIG. 5 shows a plan view of the anode side of a bipolar plate, which has a multitude of connection regions that each are arranged in a locally expanded region of an anode gas flow channel, wherein the anode gas flow channel is locally expanded by only one portion of a coolant flow channel adjacent to the anode gas flow channel being locally displaced along the transverse direction of the anode gas flow channel and only one portion of a further anode gas flow channel adjacent to the locally displaced portion of the coolant flow channel being locally narrowed, and wherein furthermore the connection regions are arranged in a regular pattern that has a first periodicity length P₁ along a longitudinal direction of the bipolar plate and a second periodicity length P₂ along a transverse direction of the bipolar plate oriented perpendicularly to the longitudinal direction and perpendicularly to the stack direction;

FIG. 6 shows a plan view of the anode side of a bipolar plate for an electrochemical unit of an electrochemical device comprising a plurality of electrochemical units that follow one another along a stack direction, wherein the bipolar plate comprises an electrochemical active region, which comprises an anode gas flow field that is able to be flowed through by an anode gas transversely to the stack direction, a cathode gas flow field that is able to be flowed through by a cathode gas transversely to the stack direction, and a coolant flow field that is able to be flowed through by a coolant transversely to the stack direction,
wherein the anode gas flow field comprises anode gas flow channels that are able to be flowed through by the anode gas, the cathode gas flow field comprises cathode gas flow channels that are able to be flowed through by the cathode gas, and the coolant flow field comprises coolant flow channels that are able to be flowed through by the coolant,
wherein the anode gas flow field is formed on an anode-side bipolar plate layer and the cathode gas flow field is formed on a cathode-side bipolar plate layer,
wherein at least one anode gas flow channel has a redirecting region at which it changes its through-flow direction by 180°, wherein a channel base of the redirecting region abuts against a channel base of a cathode gas flow channel in an overlap region, and
wherein the anode-side bipolar plate layer and the cathode-side bipolar plate layer are materially bonded to one another, preferably by welding, at a connection region within the respective overlap region;

FIG. 7 shows a cross-section through the bipolar plate from FIG. 6 outside of the redirecting region of the anode gas flow channel, along the line 7-7 in FIG. 6; and

FIG. 8 shows a cross-section through the bipolar plate from FIG. 6 in the redirecting region of the anode gas flow channel, along the line 8-8 in FIG. 6.

### DETAILED DESCRIPTION OF THE INVENTION

The same or functionally equivalent elements are provided with the same reference numerals in all Figures.

A bipolar plate 100 depicted partially in FIGS. 1 to 3 forms a constituent part of an electrochemical unit (not depicted as a whole) of an electrochemical device comprising a plurality of such electrochemical units that follow one another along a stack direction 102.

The bipolar plate 100 comprises an anode-side bipolar plate layer 104 and a cathode-side bipolar plate layer 106, which abut against one another, preferably in surface-to-surface contact, along a contact plane 108 of the bipolar plate 100 oriented perpendicularly to the stack direction 102 and are materially bonded to one another, in particular by welding, for example by laser welding, at connection regions 150 that are described in more detail in the following.

Each of the bipolar plate layers 104, 106 is preferably made from a substantially planar starting material, in particular a starting sheet metal, by means of a reshaping operation, which, in particular, may be a stamping operation or a deep drawing operation.

The starting material is an electrically conductive material, preferably a metallic material, for example a stainless steel material.

The starting material may be provided with a coating, in particular a coating that has a good electrical conductivity.

By means of the reshaping operation, beads 112 are formed on the anode-side bipolar plate layer 104 and on the cathode-side bipolar plate layer 106, said beads 112 extending out of the contact plane 108.

Each of the beads 112 comprises two bead feet 114, two bead flanks 116, and a bead crest 118 connecting the beads flanks 116 to one another.

The bead crest 118 is preferably of substantially planar configuration and is preferably oriented substantially perpendicularly to the stack direction 102.

The bead crests 118 of the anode-side bipolar plate layer 104, in the assembled state of the electrochemical device, support a component of an electrochemical unit, preferably an anode-side gas diffusion layer.

The beads 112 of the cathode-side bipolar plate layer 106, in the assembled state of the electrochemical device, also support a component of an electrochemical unit, preferably a cathode-side gas diffusion layer.

The bead flanks 116 of the beads 112 of the anode-side bipolar plate layer 104, in the unloaded rest state of the bipolar plate 100, which is depicted in FIGS. 1 to 3, enclose a flank angle da with the contact plane 108 of the bipolar plate 100.

In the loaded state of the electrochemical device, in which the electrochemical units of the electrochemical device are braced against one another by means of a clamping device (not depicted), the flank angle α′ₐ is different from the flank angle da in the rest state; typically the flank angle α′ₐ is reduced by the clamping of the electrochemical units compared to the flank angle da in the rest state.

In the unloaded rest state of the bipolar plate 100 depicted in FIGS. 1 to 3, the bead flanks 116 of the beads 112 of the cathode-side bipolar plate layer 106 enclose a flank angle αₖ with the contact plane 108 of the bipolar plate 100.

In the embodiment of a bipolar plate 100 depicted in FIGS. 1 to 3, the anode-side bipolar plate layer 104 and the cathode-side bipolar plate layer 106 are configured mirror-symmetrically to one another relative to the contact plane 108, such that the flank angles da of the beads 112 of the anode-side bipolar plate layer 104 and the flank angles αₖ of the beads 112 of the cathode-side bipolar plate layer 106 coincide with one another. However, it is also conceivable that the anode-side bipolar plate layer 104 and the cathode-side bipolar plate layer 106 are not configured mirror-symmetrically relative to the contact plane 108; in this case, the flank angle da of the beads 112 of the anode-side bipolar plate layer 104 may be different from the flank angle αₖ of the beads 112 of the cathode-side bipolar plate layer 106.

The beads 112 of the anode-side bipolar plate layer 104 each extend along a local longitudinal direction 120.

The beads 112 of the cathode-side bipolar plate layer 106 each extend along a local longitudinal direction 122.

The bead crests 118 of the beads 112 of the anode-side bipolar plate layer 104 have an anode-side web width Sₐ, which corresponds to the extent of the bead crests 118 perpendicular to the local longitudinal direction 120 of the anode-side beads 112.

The bead crests 118 of the beads 112 of the cathode-side bipolar plate layers 106 have a web width Sₖ, which corresponds to the extent of the cathode-side bead crests 118 perpendicular to the local longitudinal direction 122 of the cathode-side beads 112.

In the symmetrical embodiment of a bipolar plate 100 depicted in FIGS. 1 to 3, the anode-side web width Sₐ coincides with the cathode-side web width Sₖ.

In principle, provision may also be made that the anode-side web width Sₐ is different from the cathode-side web width Sₖ.

For example, provision may be made that the anode-side web width Sₐ is greater than the cathode-side web width Sₖ.

The region that is bound by the web flanks 116 of two adjacent beads 112 of the anode-side bipolar plate layer 104 and the channel base 124 of the anode-side bipolar plate layer 104 connecting the web feet 114 of these adjacent beads 112 to one another forms an anode gas flow channel 126.

Each anode gas flow channel 126 has a channel width Bₐ, which corresponds to the spacing of the bead feet 114 of the beads 112 of the anode-side bipolar plate layer 104 bounding the respective anode gas flow channel 126 perpendicular to the local longitudinal direction 120 of the anode-side beads 112. The anode gas flow channel 126 extends along the local longitudinal direction 120 of the beads 112 of the anode-side bipolar plate layer 104 bounding the anode gas flow channel 126.

The bead flanks 116 of adjacent beads 112 of the cathode-side bipolar plate layer 106 and the channel base 124 connecting the bead feet 114 of the adjacent beads 112 to one another together bound a respective cathode gas flow channel 128.

Each of the cathode gas flow channels 128 has a channel width Bₖ, which corresponds to the spacing of the bead feet 114 of the beads 112 of the cathode-side bipolar plate layer 106 bounding the cathode gas flow channel 128 perpendicular to the local longitudinal direction 122 of the cathode-side beads 122. The cathode gas flow channel 128 extends along the local longitudinal direction 122 of the beads 112 of the cathode-side bipolar plate 106 bounding the cathode gas flow channel 128.

In the embodiment depicted in FIGS. 1 to 3 of a symmetrically structured bipolar plate 100, the width Bₐ of the anode gas flow channels is equal to the width Bₖ of the cathode gas flow channels 128.

In principle, the width Bₐ of the anode gas flow channels 126 may be different from the width Bₖ of the cathode gas flow channels 128.

For example, provision may be made that the width Bₐ of the anode gas flow channels 126 is smaller than the width Bₖ of the cathode gas flow channels 128.

The inner faces of a respective bead 112 of the anode-side bipolar plate layer 104 and of a respective bead 112 of the cathode-side bipolar plate layer 106 facing toward one another together bound a respective coolant flow channel 130 formed between the anode-side bipolar plate layer 104 and the cathode-side bipolar plate layer 106.

Each of these coolant flow channels 130 has a width B_{c}, which corresponds to the greatest extent of the cavity bound by the adjoining beads 112 of the anode-side bipolar plate layer 104 and the cathode-side bipolar plate layer 106 perpendicular to the respective local longitudinal direction 132 of the coolant flow channel 130.

The anode gas flow channels 126 of the bipolar plate 100 together form an anode gas flow field 134 of the bipolar plate 100 formed on the anode-side bipolar plate layer 104.

The cathode gas flow channels 128 together form a cathode gas flow field 136 of the bipolar plate 100 formed on the cathode-side bipolar plate layer 106.

The coolant flow channels 130 together form a coolant flow field 138 of the bipolar plate 100 formed between the anode-side bipolar plate layer 104 and the cathode-side bipolar plate layer 106.

The anode gas flow field 134 of each bipolar plate 100, in the assembled state of the electrochemical device, is in fluidic connection with at least one anode gas supply channel, which extends in parallel with the stack direction 102 and through which an anode gas (a combustion gas that preferably contains hydrogen) is suppliable to the anode gas flow field 134, and in fluidic connection with at least one anode gas discharge channel, which extends in parallel with the stack direction 102 and by way of which anode gas is dischargeable from the anode gas flow field 134.

The cathode gas flow field 136 of each bipolar plate 100, in the assembled state of the electrochemical device, is in fluidic connection with at least one cathode gas supply channel, which extends in parallel with the stack direction 102 and by way of which a cathode gas (an oxidizing agent that preferably contains oxygen) is suppliable to the cathode gas flow field 136, and is in fluidic connection with at least one cathode gas discharge channel, which extends in parallel with the stack direction 102 and by way of which cathode gas is dischargeable from the cathode gas flow field 136.

The coolant flow field 138 of each bipolar plate 100, in the assembled state of the electrochemical device, is in fluidic connection with at least one coolant supply channel, which extends in parallel with the stack direction 102 and by way of which a coolant (preferably a liquid coolant, for example water) is suppliable to the coolant flow field 138, and in fluidic connection with at least one coolant discharge channel, which extends in parallel with the stack direction 102 and by way of which coolant is dischargeable from the coolant flow field 138.

The region of the bipolar plate 100 containing the anode gas flow field 134, the cathode gas flow field 136, and the coolant flow field 138 is referred to hereinafter as the electrochemically active region 140 of the bipolar plate 100, although no electrochemical reactions occur in these flow fields themselves.

Because the bipolar plate 100 has to enable a charge equalization between the membrane electrode units adjoining the bipolar plate 100, the bipolar plate layers 104, 106 are made of a material that has a good electrical conductivity.

Preferably, the material of the bipolar plate layers 104, 106 has a specific electrical resistance of less than 15 Ω·mm²/m.

For example, the anode-side bipolar plate layer 104 and/or the cathode-side bipolar plate layer 106 may be made of a rustproof, austenitic steel, preferably the steel with the material number 1.4404.

The specific electrical resistance of the steel with the material number 1.4404 is about 0.75 Ω·mm²/m.

Such a steel forms a natural passive layer (chromium oxide layer) on its surface, which has a low electrical conductivity. It is therefore necessary to provide the bipolar plate 100 with a conductive coating on its outer sides each facing toward an electrode of a membrane electrode unit.

If the inner sides of the bipolar plate layers 104 and 106 facing toward one another are not provided with such an electrically conductive coating, then said inner sides of the bipolar plate layers 104 and 106 must be materially bonded to one another in order to ensure the necessary electrical conductivity between the bipolar plate layers 104 and 106 of the bipolar plate 100.

Such a material bond can be established, for example, by a welding seam, wherein the welding seam may be interrupted and comprise welding seam portions that are separate from one another (stitch welds) or welding points (spots).

Such a welding connection can be produced, in particular, by laser welding.

For welding such conductive seams, the region in which the anode-side bipolar plate layer 104 and the cathode-side bipolar plate layer 106 abut against one another and are able to be welded and the width of which corresponds to the width of the channel base 124 of an anode gas flow channel 126 and/or the width of the channel base 124 of a cathode gas flow channel 128 on which the welding is to be performed must have a minimum width due to the summation of manufacturing tolerances, which result, e.g., from the tolerance of the width of the welding seam, the tolerance in the positioning of the welding seam relative to the bipolar plate layers 104, 106, and the tolerance of the relative positioning of the bipolar plate layers 104 and 106 to one another.

This minimum width is, for example, in the range of at least 0.2 mm.

In order to not have to configure all anode gas flow channels 126 and/or cathode gas flow channels 128 having this high channel base width across their entire length, provision is made in the embodiment of a bipolar plate 100 depicted in FIGS. 1 to 3 that at least one anode gas flow channel 126 is locally expanded by a respective portion 142, adjacent to the respective anode gas flow channel 126, of two coolant flow channels 130 adjacent to the anode gas flow channel 126 being locally displaced by a distance V along a transverse direction 144 of the anode gas flow channel 126 oriented perpendicularly to the local longitudinal direction 120 of the anode gas flow channel 126 and perpendicularly to the stack direction 102 (see FIG. 1).

Both coolant flow channels 130 adjacent to the locally expanded anode gas flow channel 126 hereby retain their full width B_{c} both in the displaced portion 142 of the respective coolant flow channel 142 as well as in portions 142 located in front of or behind the displaced portion 142, such that the local cross-section of these coolant flow channels 130 that is able to be flowed through by the coolant remains unchanged and thus a sufficient cooling is ensured even in the region of the local expansion of the anode gas flow channel 126.

In order to compensate for the offset V of a coolant flow channel 130 adjoining the locally expanded anode gas flow channel 126 along the transverse direction 144, a respective further anode gas flow channel 126′ adjacent to the locally displaced portion 142 of a coolant flow channel 130 is locally narrowed, namely in such a way that the channel width B′ₐ is reduced by the offset V relative to the width Bₐ of the anode gas flow channel 126′ in front of or behind the locally narrowed region 146.

Coolant flow channels 130′ adjacent to these locally narrowed anode gas flow channels 126′ are then formed in the region of the local expansion of the anode gas flow channel 126 again without offset V along the transverse direction 144.

In the locally expanded region 148 of the anode gas flow channel 126 formed by the offset V of the two adjacent coolant flow channels 130, the anode-side bipolar plate layer 104 and the cathode-side bipolar plate layer 106 are materially bonded to one another at a connection region 150.

The material bond in the connection region 150 may be configured, in particular, as a welding seam 152, in particular a stitch weld 154, connecting the two bipolar plate layers 104 and 106 to one another.

The extent e of the connection region 150 along the local longitudinal direction 120 of the expanded anode gas flow channel 126 is hereby preferably greater than the width B″ₐ of the channel base 124 of the anode gas flow channel 126 in the locally expanded region 148 of the anode gas flow channel 126.

The greatest width B″ₐ of the channel base 124 of the locally expanded region 148 of the anode gas flow channel 126 is preferably at least 0.10 mm, in particular at least 0.15 mm, particularly preferably at least 0.2 mm.

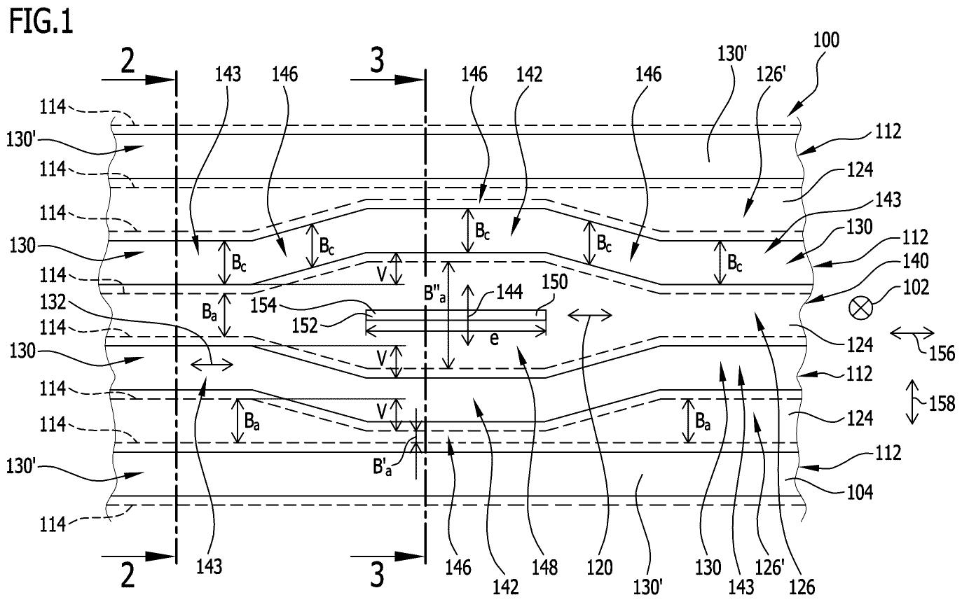

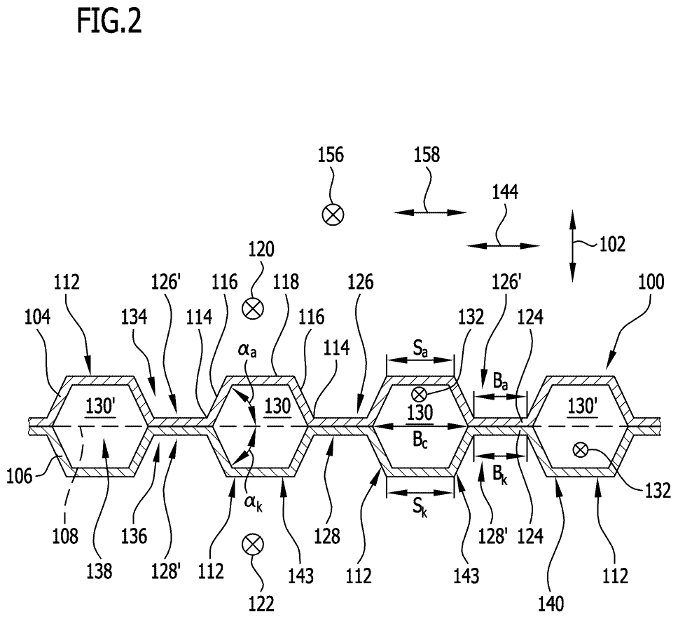

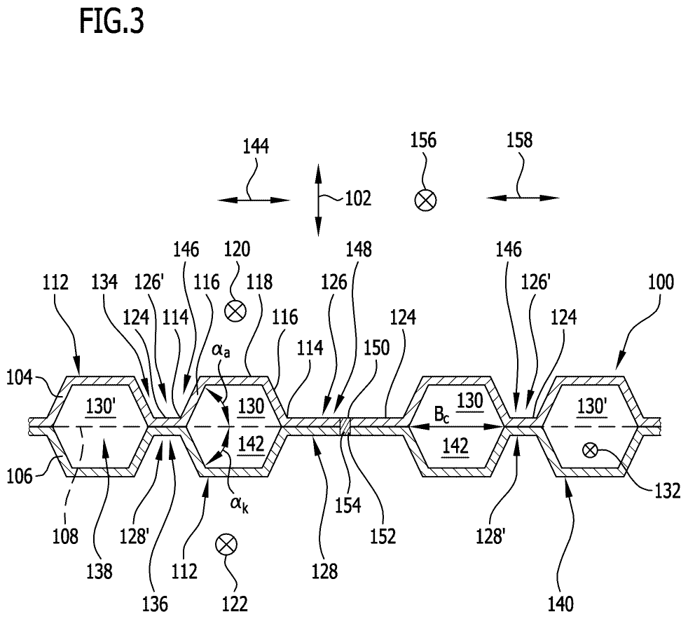

As can best be seen in FIG. 3, the flank angles αₐ, αₖ by which the flanks 116 of the displaced portion 142 of a locally displaced coolant flow channel 130 are inclined relative to the contact plane 108 of the anode-side bipolar plate layer 104 and the cathode-side bipolar plate layer 106 perpendicular to the stack direction 102 are substantially equal to the flank angles αₐ, αₖ by which the flanks 116 of a portion 143 of the coolant flow channel 130 adjacent to the displaced portion 142 are inclined relative to the contact plane 108 (see FIG. 2).

In the embodiment of a bipolar plate 100 depicted in FIGS. 1 to 3, the two displaced portions 142 of the coolant flow channels 130 adjacent to the locally expanded anode gas flow channel 126 are locally displaced to an equal extent, namely by the same offset V, along the transverse direction 144 relative to the undisplaced portions 143 of these coolant flow channels 130.

Because in the embodiment of a bipolar plate 100 depicted in FIGS. 1 to 3 the cathode gas flow channels 128 are configured mirror-symmetrically to the anode gas flow channels 126 relative to the contact plane 108, in this bipolar plate 100 at least one cathode gas flow channel 128 is also locally expanded by two portions 142 of two coolant flow channels 130 adjacent to the cathode gas flow channel 128 being locally displaced by an offset V along the transverse direction 144 of the cathode gas flow channels 128 oriented perpendicularly to the local longitudinal direction 122 of the cathode gas flow channel 128 and perpendicularly to the stack direction 102.

Furthermore, two further cathode gas flow channels 128′ adjacent to a respective one of these locally displaced portions 142 of a coolant flow channels 130 are locally narrowed.

As a result, the respective cathode gas flow channel 128 has a locally expanded region 148, wherein the anode-side bipolar plate layer 104 and the cathode-side bipolar plate layer 106 are materially bonded to one another within this locally expanded region 148 of the cathode gas flow channel 128 at the connection region 150.

The extent e of the connection region 150 along the local longitudinal direction 122 of the cathode gas flow channel 128 is preferably greater than the width B″ₖ of the channel base 124 of the cathode gas flow channel 128 in the locally expanded region 148 of the cathode gas flow channel 128.

The greatest width B″ₖ of the channel base 124 of the locally expanded region 148 of the cathode gas flow channel 128 is preferably at least 0.10 mm, in particular at least 0.15 mm, particularly preferably at least 0.2 mm.

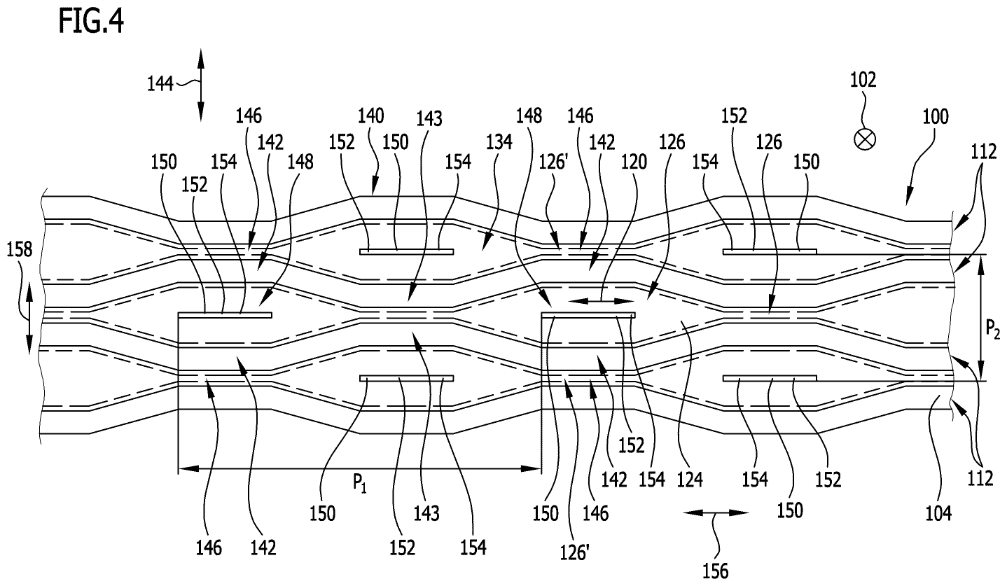

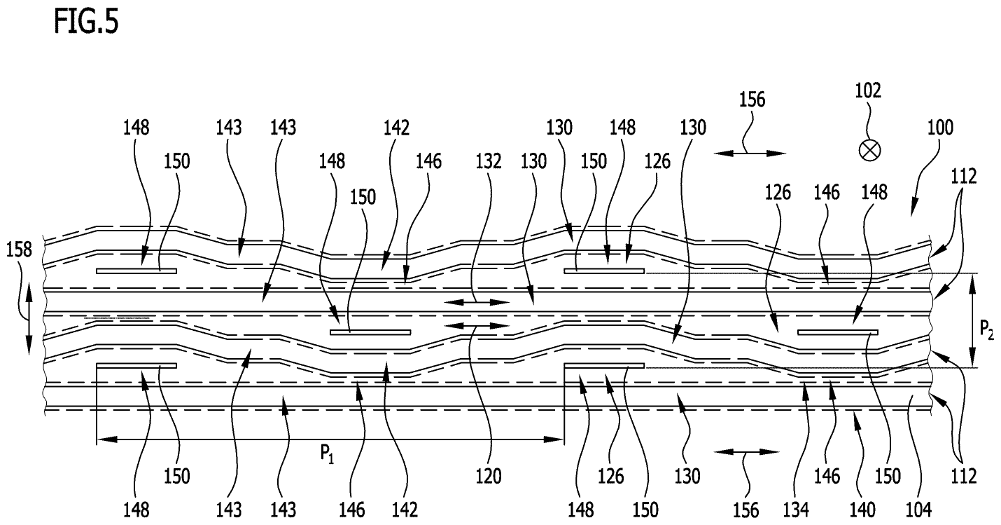

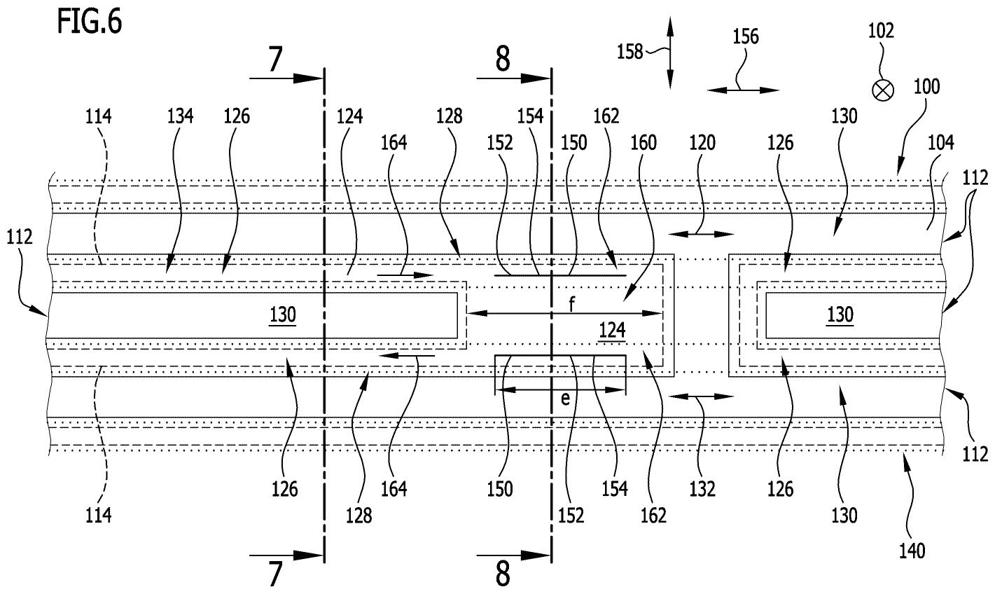

In order to be able to produce sufficient electrical conductivity between the bipolar plate layers 104 and 106 of the bipolar plate 100, the bipolar plate 100, as can be seen in FIG. 4, has a multitude of connection regions 150, which each are arranged in a locally expanded region 148 of an anode gas flow channel 126 (or a cathode gas flow channel 128) and preferably are arranged in a regular pattern that has a first periodicity length P₁ along a longitudinal direction 156 of the bipolar plate 100 and has a second periodicity length P₂ along a transverse direction 158 of the bipolar plate 100 oriented perpendicularly to the longitudinal direction 156 of the bipolar plate 100 and perpendicularly to the stack direction 102.

The longitudinal direction 156 of the bipolar plate 100 is hereby preferably oriented in parallel to the local longitudinal directions 120 of the anode gas flow channels 126 extending in the main flow direction of the anode gas.

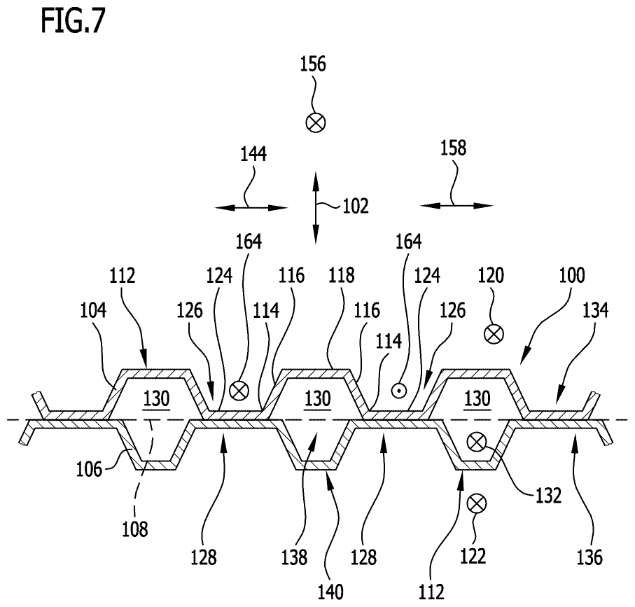

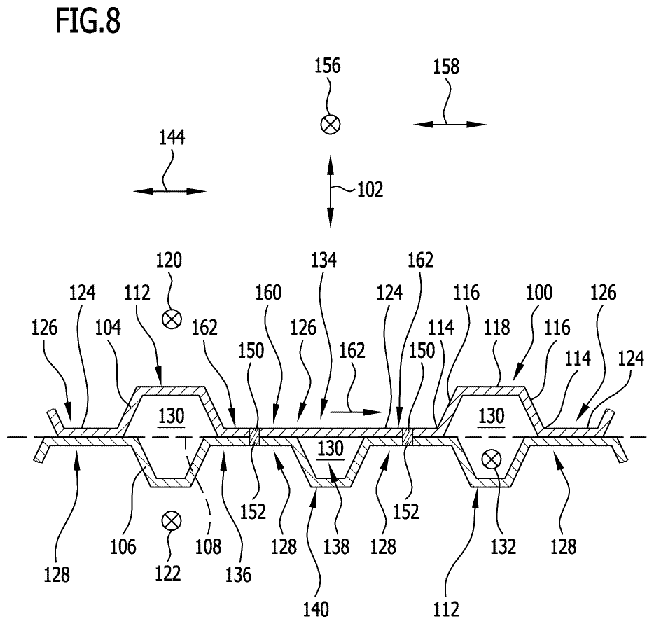

In the case of a variant depicted in FIG. 5 of the bipolar plates 100 depicted in FIGS. 1 to 4, the locally expanded regions 148 of anode gas flow channels 126 are produced by in each case only one portion 142 of one single coolant flow channel 130 adjacent to the anode gas flow channel 126 being locally displaced along the transverse direction 144 of the anode gas flow channel 126 and only one portion 146 of a further anode gas flow channel 126′ adjacent to this locally displaced portion 142 of the coolant flow channel 130 being locally narrowed.

In this embodiment, the locally expanded regions 148 of the anode gas flow channels 126 are thus not configured symmetrically relative to a plane defined by the local longitudinal direction 120 of the anode gas flow channels 126 and the stack direction 102.

In the case of this asymmetrical configuration of the locally expanded regions 148 of the anode gas flow channels 126, too, provision may be made, as shown in FIG. 5, that the connection regions 150 arranged in these locally expanded regions 148 of the anode gas flow channels 126 are arranged in a regular pattern that has a first periodicity length P₁ along the longitudinal direction 156 of the bipolar plate 100 and has a second periodicity length P₂ along the transverse direction 158 of the bipolar plate 100 oriented perpendicularly to the longitudinal direction 156 of the bipolar plate 100 and perpendicularly to the stack direction 102.

In all other respects, the embodiment of a bipolar plate 100 depicted in FIG. 5 corresponds with respect to structure, function, and production method with the embodiment of a bipolar plate 100 depicted in FIGS. 1 to 4, to which reference is made in this regard.

Depicted in FIGS. 6 to 8 is an alternative possibility for providing a locally expanded portion of an anode gas flow channel 126.

As can best be seen in FIG. 6, here an anode gas flow channel 126 has a redirecting region 160 at which the anode gas flow channel 126 changes its through-flow direction 164 by 180°, wherein a channel base 124 of the redirecting region 160 abuts against a respective channel base 124 of a cathode gas flow channel 128 in two overlap regions 162 (see FIG. 8).

In each of the two overlap regions 162 of the redirecting region 160, the anode-side bipolar plate layer 104 and the cathode-side bipolar plate layer 106 are materially bonded to one another at a respective connection region 150, preferably by welding, in particular by laser welding.

To make this possible, the extent f of the redirecting region 160 of the anode gas flow channel 126 along the local longitudinal direction 120 of the anode-side beads 112 is greater than the extent e of a respective connection region 150 along the same local longitudinal direction 120.

Between the two connection regions 150 of a redirecting region 160, a large intermediate space is available, within which the position of the connection regions 150 may vary perpendicularly to the local longitudinal direction 120 of the anode-side beads 112.

Furthermore, the extent f of each overlap region 162 along the local through-flow direction 164 of the anode gas flow channel 126 in a portion 126a of the anode gas flow channel 126 upstream from the redirecting region 160 and/or in a portion 126b of the anode gas flow channel 126 downstream from the redirecting region 160 is greater than the width Bₐ of the channel base of the anode gas flow channel 126 outside of the respective redirecting region 160.

In order to be able to produce sufficient electrical conductivity between the bipolar plate layers 104 and 106 of the bipolar plate 100, embodiment of a bipolar plate 100 depicted in FIGS. 6 to 8 preferably has as a multitude of redirecting regions 160, which are arranged in a regular pattern that has a first periodicity length P₁ along a longitudinal direction 156 of the bipolar plate 100 and has a second periodicity length P₂ along a transverse direction 158 of the bipolar plate 100 oriented perpendicularly to the longitudinal direction 156 of the bipolar plate 100 and perpendicularly to the stack direction 102.

The longitudinal direction 156 of the bipolar plate 100 is hereby preferably oriented in parallel to the local longitudinal direction 120 of the anode gas flow channels 126 extending in the main flow direction of the anode gas.

In a variant of the embodiment of a bipolar plate 100 depicted in FIGS. 6 to 8, said variant not being graphically represented, provision is made that at least one cathode gas flow channel 128 has a redirecting region 160 at which it changes its through-flow direction, wherein a channel base 124 of the redirecting region 160 abuts against a channel base 124 of an anode gas flow channel 126 in an overlap region 162, wherein the anode-side bipolar plate layer 104 and the cathode-side bipolar plate layer 106 are materially bonded to one another at a connection region within the respective overlap region 160.

Preferably, provided in the redirecting region of the cathode gas flow channel are two respective such overlap regions 162 in which the anode-side bipolar plate layer 104 and the cathode-side bipolar plate layer 106 are materially bonded to one another at a respective connection region 150, preferable by welding, for example by laser welding.

The extent f of the overlap region 162 along the local through-flow direction of the cathode gas flow channel 128 in a portion 128a of the cathode gas flow channel 128 upstream from the flow redirecting region 160 of the cathode gas flow channel 128 and/or in a portion 128b of the cathode gas flow channel 128 downstream from the redirecting region 160 of the cathode gas flow channel 128 is hereby preferably greater than the width Bₖ of the channel base 124 of the cathode gas flow channel 128 outside of the respective redirecting region 160.

The redirecting regions 160 of the cathode gas flow channels 128 may also be arranged on the bipolar plate 100 in a regular pattern that has a first periodicity length P₁ along the longitudinal direction 156 of the bipolar plate 100 and a second periodicity length P₂ along a transverse direction 158 of the bipolar plate 100 oriented perpendicularly to the longitudinal direction 156 and perpendicularly to the stack direction 102.

The bipolar plates 100 described above are suited for use in an electrochemical device comprising a plurality of electrochemical units that follow one another along the stack direction 102 and each comprise a respective bipolar plate 100.

1. A bipolar plate for an electrochemical unit of an electrochemical device comprising a plurality of electrochemical units that follow one another along a stack direction, wherein the bipolar plate comprises the following:
an electrochemically active region, which comprises an anode gas flow field that is able to be flowed through by an anode gas transversely to the stack direction, a cathode gas flow field that is able to be flowed through by a cathode gas transversely to the stack direction, and a coolant flow field that is able to be flowed through by a coolant transversely to the stack direction,
wherein the anode gas flow field comprises anode gas flow channels that are able to be flowed through by the anode gas, the cathode gas flow field comprises cathode gas flow channels that are able to be flowed through by the cathode gas, and the coolant flow field comprises coolant flow channels that are able to be flowed through by the coolant,
wherein the anode gas flow field is formed on an anode-side bipolar plate layer and the cathode gas flow field is formed on a cathode-side bipolar plate layer,
wherein at least one of the following applies:
a) at least one anode gas flow channel is locally expanded by at least one portion of a coolant flow channel adjacent to the anode gas flow channel being locally displaced along a transverse direction of the anode gas flow channel oriented perpendicularly to the local longitudinal direction of the anode gas flow channel and perpendicularly to the stack direction and by a portion of a further anode gas flow channel adjacent to the locally displaced portion of the coolant flow channel being locally narrowed,
and
b) at least one cathode gas flow channel is locally expanded by at least one portion of a coolant flow channel adjacent to the cathode gas flow channel being displaced locally along a transverse direction of the cathode gas flow channel oriented perpendicularly to the local longitudinal direction of the cathode gas flow channel and perpendicularly to the stack direction and by a further cathode gas flow channel adjacent to the locally displaced portion of the coolant flow channel being locally narrowed;
wherein the anode-side bipolar plate layer and the cathode-side bipolar plate layer are materially bonded to one another at at least one connection region within at least one of i) the locally expanded region of the anode gas flow channel and ii) the locally expanded region of the cathode gas flow channel.

2. The bipolar plate layer in accordance with claim 1, wherein the connection region is configured as a stitch weld.

3. The bipolar plate layer in accordance with claim 1, wherein at least one of the following applies:
a) the extent of the connection region along the local longitudinal direction of the anode gas flow channel is greater than the width of the channel base of the anode gas flow channel in the locally expanded region of the anode gas flow channel,
and
b) the extent of the connection region along the local longitudinal direction of the cathode gas flow channel is greater than the width of the channel base of the cathode gas flow channel in the locally expanded region of the cathode gas flow channel.

4. The bipolar plate in accordance with claim 1, wherein the anode-side bipolar plate layer and the cathode-side bipolar plate layer are welded to one another at the connection region.

5. The bipolar plate in accordance with claim 1, wherein the greatest width of the channel base of the locally expanded region of the anode gas flow channel or the greatest width of the channel base of the locally expanded region of the cathode gas flow channel is at least 0.1 mm.

6. The bipolar plate in accordance with claim 1, wherein the width of the displaced portion of the coolant flow channel is substantially equal to the width of an undisplaced portion of the coolant flow channel adjacent to the displaced portion.

7. The bipolar plate in accordance with claim 1, wherein the flank angles by which the flanks of the displaced portion of the coolant flow channel are inclined relative to a contact plane of the anode-side bipolar plate layer and the cathode-side bipolar plate layer perpendicular to the stack direction are substantially equal to the flank angles by which the flanks of a portion of the coolant flow channel adjacent to the displaced portion are inclined relative to the contact plane.

8. The bipolar plate layer in accordance with claim 1, wherein at least one of the following applies:
a) portions of two coolant flow channels adjacent to the anode gas flow channel are locally displaced away from one another along the transverse direction and two further anode gas flow channels adjacent to these two coolant flow channels are locally narrowed,
and
b) portions of two coolant flow channels adjacent to the cathode gas flow channel are locally displaced away from one another along the transverse direction and two further cathode gas flow channels adjacent to these two coolant flow channels are narrowed.

9. The bipolar plate in accordance with claim 8, wherein the displaced portions of the coolant flow channels adjacent to the anode gas flow channel or the cathode gas flow channel are locally displaced to an equal extent along the transverse direction relative to undisplaced portions of these coolant flow channels.

10. The bipolar plate in accordance with claim 1, wherein at least one of the following applies:
a) only one portion of one single coolant flow channel adjacent to the anode gas flow channel is locally displaced along a transverse direction and a further anode gas flow channel adjacent to this coolant flow channel is locally narrowed,
and
b) only one portion of one single coolant flow channel adjacent to the cathode gas flow channel is locally displaced along a transverse direction and a further cathode gas flow channel adjacent to this coolant flow channel is narrowed,
wherein a locally asymmetrical expansion of the respective anode gas flow channel or the respective cathode gas flow channel is achieved in this way.

11. The bipolar plate in accordance with claim 1, wherein the bipolar plate comprises a multitude of connection regions, which are arranged in a regular pattern that has a first periodicity length along a longitudinal direction of the bipolar plate and a second periodicity length along a transverse direction of the bipolar plate oriented perpendicularly to the longitudinal direction and perpendicularly to the stack direction.

12. A bipolar plate for an electrochemical unit of an electrochemical device comprising a plurality of electrochemical units that follow one another along a stack direction, wherein the bipolar plate comprises the following:
an electrochemically active region, which comprises an anode gas flow field that is able to be flowed through by an anode gas transversely to the stack direction, a cathode gas flow field that is able to be flowed through by a cathode gas transversely to the stack direction, and a coolant flow field that is able to be flowed through by a coolant transversely to the stack direction,
wherein the anode gas flow field comprises anode gas flow channels that are able to be flowed through by the anode gas, the cathode gas flow field comprises cathode gas flow channels that are able to be flowed through by the cathode gas, and the coolant flow field comprises coolant flow channels that are able to be flowed through by the coolant,
wherein the anode gas flow field is formed on an anode-side bipolar plate layer and the cathode gas flow field is formed on a cathode-side bipolar plate layer,
wherein at least one of the following applies:
a) at least one anode gas flow channel has a redirecting region at which it changes its through-flow direction, wherein a channel base of the redirecting region abuts against a channel base of a cathode gas flow channel in an overlap region,
and
b) at least one cathode gas flow channel has a redirecting region at which it changes its through-flow direction, wherein a channel base of the redirecting region abuts against a channel base of an anode gas flow channel in an overlap region,
wherein the anode-side bipolar plate layer and the cathode-side bipolar plate layer are materially bonded to one another at at least one connection region within the respective overlap region.

13. The bipolar plate in accordance with claim 12, wherein the extent of the connection region along the local through-flow direction of the anode gas flow channel in at least one of i) a portion before the redirecting region of the anode gas flow channel and ii) a portion after the redirecting region of the anode gas flow channel or the extent of the connection region along the local through-flow direction of the cathode gas flow channel in at least one of i) a portion before the redirecting region of the cathode gas flow channel and ii) a portion after the redirecting region of the cathode gas flow channel is greater than the width of the channel base of the anode gas flow channel or the width of the channel base of the cathode gas flow channel outside of the respective redirecting region.

14. The bipolar plate in accordance with claim 12, wherein the extent of the overlap region along the local through-flow direction of the anode gas flow channel in at least one of i) a portion before the redirecting region of the anode gas flow channel and ii) a portion after the redirecting region of the anode gas flow channel or the extent of the overlap region along the local through-flow direction of the cathode gas flow channel in at least one of i) a portion before the redirecting region of the cathode gas flow channel and ii) a portion after the redirecting region of the cathode gas flow channel is greater than the width of the channel base of the anode gas flow channel or the width of the channel base of the cathode gas flow channel outside of the respective redirecting region.

15. The bipolar plate in accordance with claim 12, wherein the bipolar plate has a multitude of redirecting regions, which are arranged in a regular pattern that has a first periodicity length along a longitudinal direction of the bipolar plate and a second periodicity length along a transverse direction of the bipolar plate oriented perpendicularly to the longitudinal direction and perpendicularly to the stack direction.

16. An electrochemical device, comprising a plurality of electrochemical units that follow one another along a stack direction and each comprise a bipolar plate, said bipolar plate comprising the following:
an electrochemically active region, which comprises an anode gas flow field that is able to be flowed through by an anode gas transversely to the stack direction, a cathode gas flow field that is able to be flowed through by a cathode gas transversely to the stack direction, and a coolant flow field that is able to be flowed through by a coolant transversely to the stack direction,
wherein the anode gas flow field comprises anode gas flow channels that are able to be flowed through by the anode gas, the cathode gas flow field comprises cathode gas flow channels that are able to be flowed through by the cathode gas, and the coolant flow field comprises coolant flow channels that are able to be flowed through by the coolant,
wherein the anode gas flow field is formed on an anode-side bipolar plate layer and the cathode gas flow field is formed on a cathode-side bipolar plate layer,
wherein at least one of the following applies:
a) at least one anode gas flow channel is locally expanded by at least one portion of a coolant flow channel adjacent to the anode gas flow channel being locally displaced along a transverse direction of the anode gas flow channel oriented perpendicularly to the local longitudinal direction of the anode gas flow channel and perpendicularly to the stack direction and by a portion of a further anode gas flow channel adjacent to the locally displaced portion of the coolant flow channel being locally narrowed,
and
b) at least one cathode gas flow channel is locally expanded by at least one portion of a coolant flow channel adjacent to the cathode gas flow channel being displaced locally along a transverse direction of the cathode gas flow channel oriented perpendicularly to the local longitudinal direction of the cathode gas flow channel and perpendicularly to the stack direction and by a further cathode gas flow channel adjacent to the locally displaced portion of the coolant flow channel being locally narrowed;
wherein the anode-side bipolar plate layer and the cathode-side bipolar plate layer are materially bonded to one another at at least one connection region within at least one of i) the locally expanded region of the anode gas flow channel and ii) the locally expanded region of the cathode gas flow channel.
